(19) United States
(12) Patent Application Publication
(10) Pub. No.: US 2016/0378373 A1
(43) Pub. Date: Dec. 29, 2016

(54) DATA BACKUP METHOD AND DATA RECOVERY METHOD BY USING A CABLE WITH STORAGE FUNCTION

(71) Applicant: PHOTOFAST COMPANY LTD., Taipei City (TW)

(72) Inventor: Warren WANG, Taipei City (TW)

(21) Appl. No.: 14/837,885

(22) Filed: Aug. 27, 2015

(30) Foreign Application Priority Data
Jun. 24, 2015 (TW) 104120298

(51) Int. Cl. G06F 3/06

(52) U.S. Cl. CPC G06F 3/0619; G06F 3/065; G06F 3/0679

(57) ABSTRACT

A data backup method and a data recovery method by using a cable with storage function are disclosed in the present invention. When an electronic device is connected with a cable, the data backup or data recovery can be processed. Since the cable is required when the electronic device needs to be charged or be connected with a computer, the user will carry the cable all the time and the data backup and the data recovery can be executed at anytime and anywhere. The drawbacks that the data has not been backed up for a long time and the backup data is very different from the data within the electronic device can be avoided. The convenience of the data backup and the data recovery is increased.

### CROSS-REFERENCE TO RELATED APPLICATIONS

This application claims the benefit of Taiwan patent application No. 104120298, filed on Jun. 24, 2015, the disclosure of which is incorporated herein in its entirety by reference.

### BACKGROUND OF THE INVENTION

1. Field of the Invention

The present invention relates to a data backup method and a data recovery method, and more particularly to implementation of a cable with storage function to perform the data backup method and the data recovery method.

2. Description of Related Art

Most people nowadays like to use electronic devices and usually use the electronic devices for keeping track of things. For example, the electronic devices are used to record photos, calendar or contact data. However, memory storage volume included in the electronic devices is limited. When more and more data is required to be stored, the memory storage volume in the electronic device will run out very soon. Therefore, the data saved in the electronic devices is required to be reorganized, and unnecessary data should be deleted or moved to different storage devices.

In addition, as long as the data is stored in the memory of the electronic device, the user will lose those data when the electronic device is missing or the memory of the electronic device is damaged. Therefore, the user needs to record the data again. During a recording procedure, some of the data will be missing to cause inconvenience for the user and some of the data, such as photos and so on, cannot be recovered. If lost, those data cannot be retrieved. The conventional technology is to connect the electronic device with a computer and the data in the electronic device can be stored in the computer. Those data is stored in both of the electronic device and the computer to avoid the inconvenience when the electronic device is missing or damaged.

However, the conventional technique has to connect the electronic device to the computer to perform the data backup function. If the user does not have a computer readily available, the data cannot be backed up immediately. Moreover, if the user has not connected the electronic device with the computer for a long time, the data created from the electronic device of the user during this period of time cannot be backed up to the computer. Therefore, the data stored in the computer is different from the data stored in the electronic device. When the electronic device has not been connected to the computer for a longer time, the difference between the data in the computer and the electronic device is greater and greater. Therefore, the data of the electronic device is stored in the computer but the data has not been updated for a long time. When the user loses the electronic device, only the old data saved long time ago can be retrieved from the computer and the data saved in the electronic device recently is not saved in the computer. The loss of the data still happens and the inconvenience for the user is caused.

### SUMMARY OF THE INVENTION

Since the conventional data backup technique to store data in the computer is not convenient, an objective of the present invention is to provide a data backup method and a data recovery method by using a cable with storage function. The user can back up data frequently and inconvenience of losing data stored in an electronic device can be reduced.

In order to achieve the aforementioned objective, a data backup method by using a cable with storage function executed by an electronic device comprises steps of:

determining whether a backup signal is received and a cable with storage function is connected, wherein the cable with storage function is a cable having a flash memory module;

executing a backup procedure when the backup signal is received and the cable is connected;

transmitting data saved in the electronic device to store in the cable when the backup procedure is executed;

confirming whether the data is stored in the cable with storage function; and

ending the backup procedure when the data is stored in the cable with storage function.

Since the cable can be used for the electronic device to charge or transfer the data by connecting with the computer, the user will carry the cable all the time. The present invention can implement the cable to back up the data when the electronic device uses the cable to charge. Therefore, the backup data can be updated frequently, and the inconvenience of losing the data stored in the electronic device can be reduced.

In addition, the data recovery method by using the cable with storage function in the present invention is executed by an electronic device, and the method includes steps of:

determining whether a recovery signal is received and a cable with storage function is connected, wherein the cable with storage function is a cable having a flash memory module;

executing a recover procedure when the recovery signal is received and the cable is connected;

choosing one data in the cable with storage function to transmit to the electronic device when the recover procedure is executed;

confirming whether the data is stored in the electronic device; and

ending the recover procedure when the data is stored in the electronic device.

When the electronic device of the user is lost and replaced with a new electronic device or the memory of the electronic device is damaged to cause the loss of the data, the user can implement the cable to recover the data saved in the memory unit of the cable back to the electronic device. The recording data within the electronic device can be recovered and the user is not requested to input the data again. Therefore, the convenience is increased.

### BRIEF DESCRIPTION OF THE DRAWINGS

FIG. 1 is a flow chart of a data backup method by using a cable with storage function in a preferred embodiment of the present invention;

FIG. 2 is a schematic view of a connection between an electronic device and a cable with storage function;

FIG. 3A-FIG. 3D are schematic views of a display screen of the electronic device showing the data backup method is performed by the cable with storage function;

FIG. 4 is a flow chart of a data recovery method by using the cable with storage function in the preferred embodiment of the present invention; and

FIG. 5A-FIG. 5E are schematic views of the display screen of the electronic device showing the data recovery method is performed by the cable with storage function.

### DETAILED DESCRIPTION OF THE PREFERRED EMBODIMENT

These and other aspects of the embodiments herein will be better appreciated and understood when considered in conjunction with the following description and the accompanying drawings.

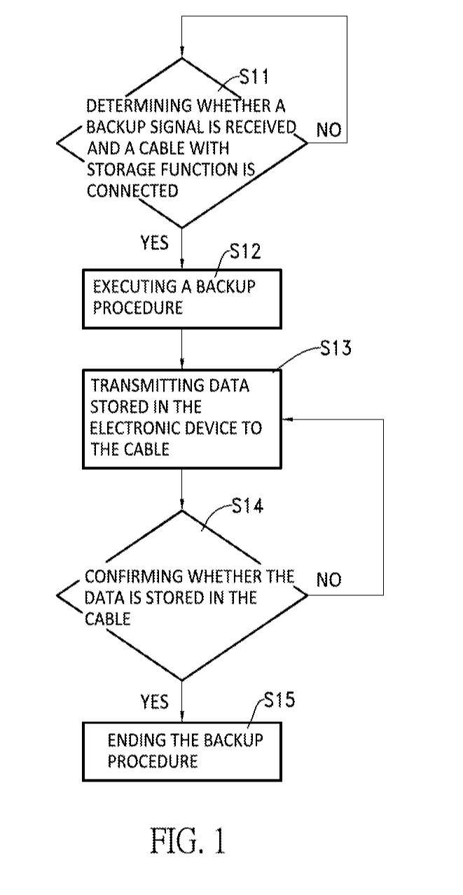

With reference to FIG. 1, a data backup method and a data recovery method by using a cable with storage function is disclosed in the present invention. The data backup method performed in the cable with storage function is executed by an electronic device. The data backup method includes the following steps:

determining whether a backup signal is received and a cable with storage function is connected (S11);

executing a backup procedure when the backup signal is received and the cable is connected (S12);

transmitting data stored in the electronic device to the cable when the backup procedure is executed, such that the cable stores the data transmitted from the electronic device (S13);

confirming whether the data of the electronic device is completely transmitted to and stored in the cable (S14);

ending the backup procedure when the data of the electronic device is completely transmitted to and stored in the cable (S15).

The cable with storage function is a cable having a flash memory module for data storing. Two ends of the cable are connectors. One of the connectors is used to be connected with an electronic device, and the other connector is used to be connected with a computer or a charger. The present invention is to connect the cable with the electronic device and the data within the electronic device can be backed up. When the electronic device needs to be charged or connected to a computer to transfer the data to the computer, the cable can be connected to the electronic device with the charger or the computer. Therefore, users have to carry the cable all the time. The present invention can back up the data in the cable when the electronic device is charged by using the cable. Alternatively, when the electronic device is connected with the computer by the cable, the data can be backed up in the cable to update the backup data frequently and the inconvenience of losing the data in the electronic device can be reduced.

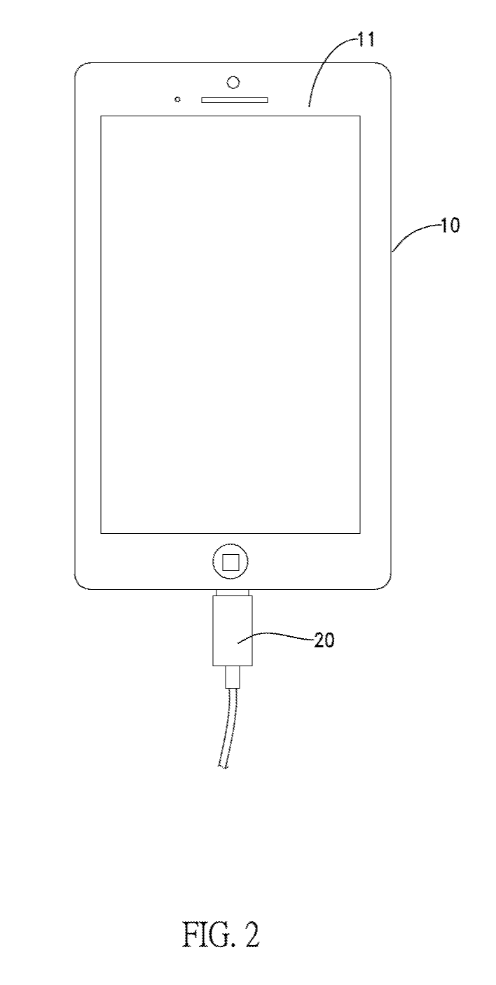

With reference to FIG. 2, when the present invention performs data backup, the electronic device 10 is connected with the cable 20 and the electronic device 10 executes an application.

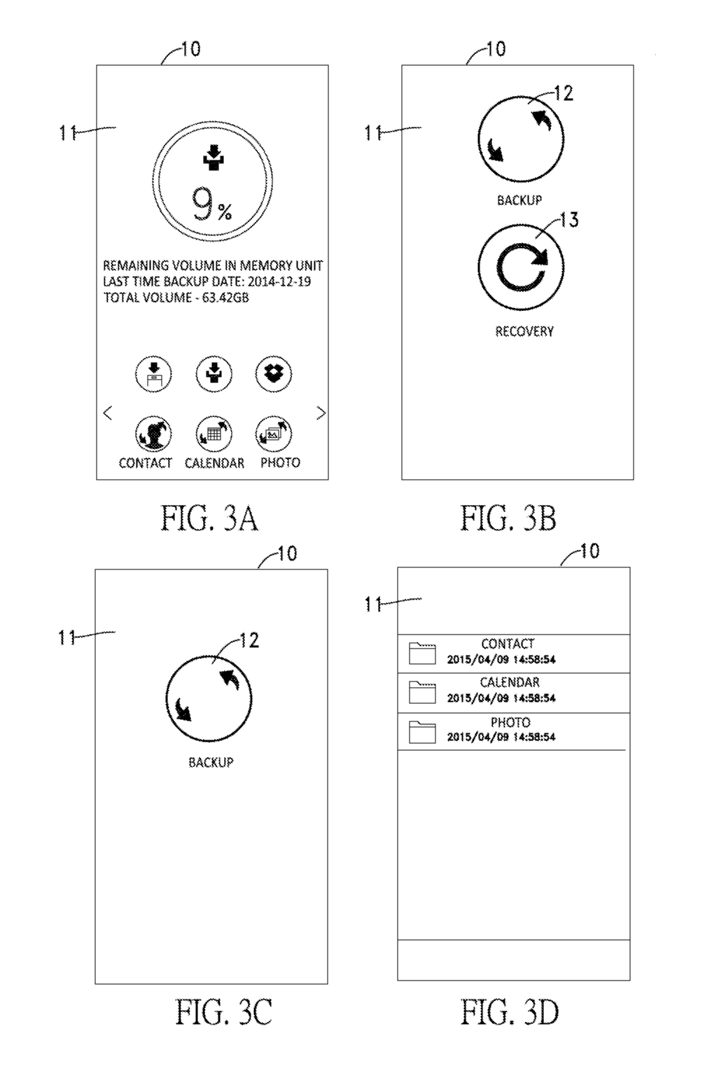

With reference to FIG. 3A, when the electronic device 10 executes the application, a display screen 11 of the electronic device shows a remaining volume of the storage in the cable 20 for the electronic device 10 to back up data. The application provides many different kinds of backup functions for the user to choose. For example, the user can choose to back up the data related to contact data, calendar, photo, or any combinations thereof. In other words, the data can be contact data, calendar data, photo data, or any combinations thereof. In the preferred embodiment, the user chooses to back up all of the data.

With reference to FIG. 3B, when the user chooses to back up all of the data, the display screen 11 of the electronic device 10 shows a backup icon 12 and a recover icon 13 for the user to choose that either the data within the electronic device will be backed up in the cable or the data within the cable will be transferred to be recovered in the electronic device.

With reference to FIG. 3C, when the user chooses the backup icon 12, the electronic device 10 receives a backup signal generated when the user chooses the backup icon and the electronic device 10 is connected with the cable 20 (step S11). When the electronic device 10 receives the backup signal and the electronic device 10 is confirmed to be connected with the cable 20, the backup procedure can be started to be executed (step S12). When the backup procedure is executed, the electronic device will transfer the data within the electronic device 10 to the cable 20 to back up (step S13). When the data within the electronic device 10 is transferred to the cable 20, the electronic device 10 confirms whether the data is stored in the cable 20. When the data is stored in the cable 20, the backup procedure will be ended (step S14). When the cable 20 is not finished with storing the data, the step S13 will be executed one more time.

With reference to FIG. 3D, when the backup procedure is ended, the electronic device shows the data stored in a memory unit of the cable 20 for the user to review. In the preferred embodiment, since the user chooses the function to back up all of the data, the display screen in FIG. 3D shows that the backup data includes the contact data, the calendar and the photo.

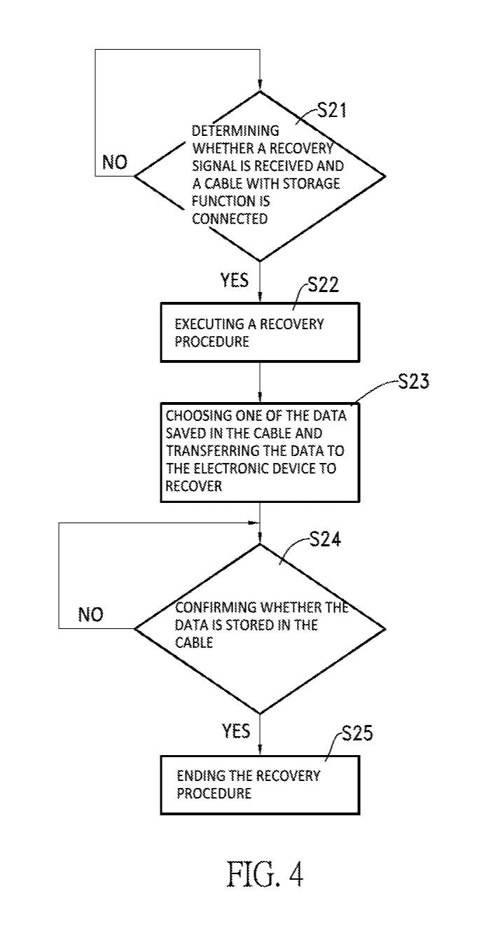

With reference to FIG. 4, the data recover method in the cable with storage function is executed by the electronic device 10 and the data recovery method includes the following steps:

determining whether a recovery signal is received and a cable with storage function is connected (S21);

executing a recover procedure when the recovery signal is received and the cable is connected (S22);

choosing one data in the cable to transmit the data to the electronic device when the recover procedure is executed (S23);

confirming whether the data is completely stored in the electronic device (S24);

ending the recover procedure when the data is completely stored in the electronic device (S25).

When the electronic device 10 of the user is lost and replaced with a new electronic device or the flash memory of the electronic device 10 is damaged to cause loss of the data, the user can connect the electronic device 10 or the new electronic device with the cable 20 to recover the data within the cable 20 into the electronic device and the data within the electronic device 10 is recovered. The user is not required to input the data again and the convenience is increased.

With reference to FIG. 2, when the data recover is processed in the present invention, the electronic device 10 is connected with the cable 20 and the electronic device 10 executes the application.

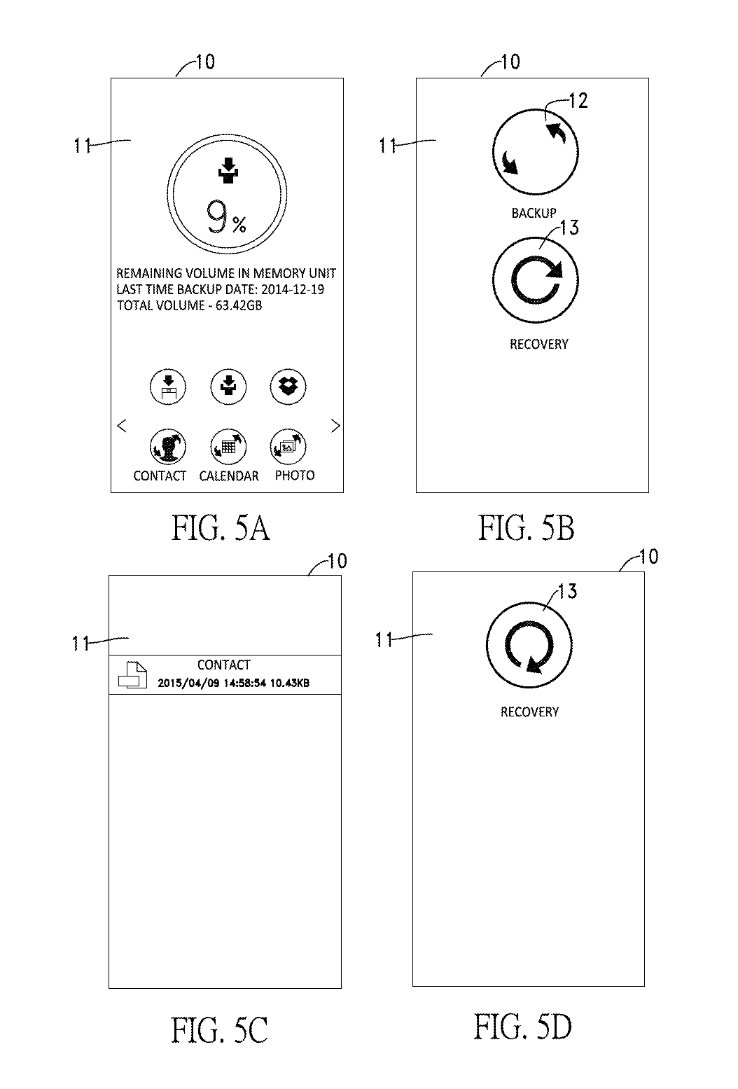

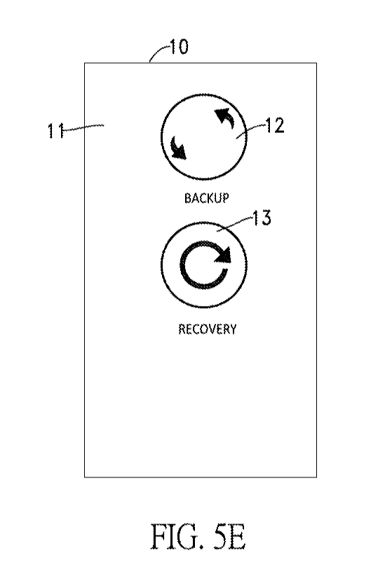

With reference to FIG. 5A, when the electronic device 10 executes the application, the display screen 11 of the electronic device 10 shows the remaining volume of the storage in the cable 20 available for the electronic device 10 to back up. If the data recover has been executed before, the previous date of the data recovery will be shown as a reference for the user. The application provides many different kinds of backup functions for the user to choose. For example, the user can choose to back up the data related to contact data, calendar, photo, or any combinations thereof. In other words, the data can be contact data, calendar data, photo data, or any combinations thereof. In the preferred embodiment, the user chooses to back up or recover the contact data.

With reference to FIG. 5B, when the user chooses to back up or recover the contact data, the display screen 11 of the electronic device 10 will show the backup icon 12 and the recover icon 13 for the user to choose that either the data within the electronic device will be back up in the cable or the data within the cable will be transferred to recover in the electronic device. When the user chooses the backup icon 13, the electronic device 10 receives the backup signal generated at the time when the user chooses the backup icon 12 and the electronic device 10 confirms whether the electronic device 10 is connected with the cable 20 (step S21). When the electronic device 10 receives the backup signal and the electronic device 10 is confirmed to be connected with the cable 20, the backup procedure can be started to be executed (step S22). If the electronic device 10 does not receive the recovery signal or the electronic device 10 and the cable 20 are not connected, the electronic device 10 re-confirms whether the backup signal is received or the electronic device 10 and the cable 20 are connected (step S21).

With reference to FIG. 5C, when the backup procedure is executed, the electronic device 10 shows at least one contact data for the user to choose (S23) and the user can choose which contact data is going to be recovered from the cable 20 to the electronic device 10. In the preferred embodiment, the at least one contact data is the contact data which the user backed up from the electronic device 10 to the cable 20. The user repeatedly transfers the contact data from the electronic device 10 to back up in the cable 20 at different time, so more than one contact data in the cable 20 can be chosen for the user and each one of the contact data is developed at different time.

With reference to FIG. 5D, when the user chooses one of the contact data, the electronic device 10 will transfer the contact data saved in the cable 20 by the user back to the electronic device 10 and the contact data is stored in the electronic device (step S23). The electronic device 10 confirms whether the data storing is finished (step S24).

With reference to FIG. 5E, when the data in the cable 20 is completely transmitted to and stored in the electronic device 10, the backup procedure is ended (step S25), and the backup icon 12 and the recover icon 13 are shown in the display screen 11 of the electronic device 10. When the data to store in the electronic device 10 is not finished storing, the step S23 is repeated.

While the present invention has been described in terms of what are presently considered to be the most practical and preferred embodiments, it is to be understood that the present invention need not be restricted to the disclosed embodiment. On the contrary, it is intended to cover various modifications and similar arrangements included within the spirit and scope of the appended claims which are to be accorded with the broadest interpretation so as to encompass all such modifications and similar structures. Therefore, the above description and illustration should not be taken as limiting the scope of the present invention which is defined by the appended claims.

What is claimed is:

1. A data backup method by using a cable with storage function, the data backup method executed by an electronic device and comprising steps of:
determining whether a backup signal is received and a cable with storage function is connected, wherein the cable with storage function is a cable having a flash memory module;
executing a backup procedure when the backup signal is received and the cable is connected;
transmitting data stored in the electronic device to the cable when the backup procedure is executed;
confirming whether the data is completely transmitted to and stored in the cable with storage function; and
ending the backup procedure when the data is stored in the cable with storage function.

2. The data backup method by using a cable with storage function as claimed in claim 1, wherein the data is contact data, calendar data or photo data.

3. A data recovery method by using a cable with storage function and the method executed by an electronic device and comprising steps of:
determining whether a recovery signal is received and a cable with storage function is connected, wherein the cable with storage function is a cable having a flash memory module;
executing a recover procedure when the recovery signal is received and the cable with storage function is connected;
choosing one data in the cable with storage function to transmit to the electronic device when the recover procedure is executed;
confirming whether the data is stored in the electronic device; and
ending the recover procedure when the data is stored in the electronic device.

4. The data recovery method by using a cable with storage function as claimed in claim 3, wherein the data is contact data, calendar data or photo data.
